(19) United States
(12) Patent Application Publication
(10) Pub. No.: US 2022/0049960 A1
(43) Pub. Date: Feb. 17, 2022

(54) METHOD AND DEVICE FOR ALIGNING COORDINATE SYSTEMS, ELECTRONIC DEVICE AND STORAGE MEDIUM

(71) Applicant: Zhejiang SenseTime Technology Development Co., Ltd., Hangzhou (CN)

(72) Inventors: Weijian XIE, Hangzhou (CN); Quanhao QIAN, Hangzhou (CN); Nan WANG, Hangzhou (CN); Guofeng ZHANG, Hangzhou (CN)

(73) Assignee: Zhejiang SenseTime Technology Development Co., Ltd., Hangzhou (CN)

(21) Appl. No.: 17/452,988

(22) Filed: Oct. 29, 2021

Related U.S. Application Data
(63) Continuation of application No. PCT/CN2020/080467, filed on Mar. 20, 2020.

(30) Foreign Application Priority Data
Jun. 28, 2019 (CN) 201910577448.2

(51) Int. Cl. G01C 21/00; G01S 5/00

(52) U.S. Cl. CPC G01C 21/005; G01S 5/0072

(57) ABSTRACT

A method for aligning coordinate systems includes: in response to that a second terminal triggers alignment of the coordinate systems, obtaining, by the second terminal, map information stored in a cloud or obtaining, by the second terminal, the map information from a first terminal; and transforming, by the second terminal, a second coordinate system of the second terminal into an initial coordinate system corresponding to the map information stored in the cloud or obtained from the first terminal, or transforming, by the second terminal, the initial coordinate system corresponding to the map information stored in the cloud or obtained from the first terminal into the second coordinate system of the second terminal; herein the initial coordinate system is used for defining a positional relationship between the first terminal and the second terminal when the map information is in a sharing state.

### CROSS-REFERENCE TO RELATED APPLICATIONS

The is a continuation of International Application No. PCT/CN2020/080467 filed on Mar. 20, 2020, which claims priority to Chinese Patent Application No. 201910577448.2 filed on Jun. 28, 2019. The disclosures of these applications are hereby incorporated by reference in their entirety.

### BACKGROUND

Multiple terminals can move and localize themselves in their respective coordinate systems. With the development of the localization technology, a localization technique based on a shared map is used in a wide variety of application scenarios. For example, in an application scenario, the Simultaneous Localization and Mapping (SLAM) refers to a technique that a robot begins to move from an unknown position in an unknown environment, and localizes itself according to position estimation and a map during the movement. The SLAM enables the robot to implement autonomous localization and map sharing.

If multiple terminals share a same map, that is to say, the terminals move and localize themselves in the shared map, the terminals need to be aligned with a same coordinate system so that they can localize each other accurately. However, effective solutions to align the coordinate systems are absent from related technologies.

### SUMMARY

The disclosure relates to the field of the localization technology, and particularly to, a method and device for aligning coordinate systems, an electronic device and a storage medium.

Technical solutions for aligning coordinate systems are proposed in the disclosure.

An aspect according to the embodiments of the disclosure provides a method for aligning the coordinate systems, the method including: in response to that a second terminal triggers the alignment of the coordinate systems, obtaining, by the second terminal, map information stored in a cloud or obtaining, by the second terminal, the map information from a first terminal; and transforming, by the second terminal, a second coordinate system of the second terminal into an initial coordinate system corresponding to the map information stored in the cloud or into the initial coordinate system corresponding to the map information obtained from the first terminal or transforming, by the second terminal, the initial coordinate system corresponding to the map information stored in the cloud or the initial coordinate system corresponding to the map information obtained from the first terminal into the second coordinate system of the second terminal; herein the initial coordinate system is used for defining a positional relationship between the first terminal and the second terminal when the map information is in a sharing state.

An aspect according to the embodiments of the disclosure provides an electronic device. The electronic device includes a memory storing processor-executable instructions; and a processor configured to execute the stored processor-executable instructions to perform operations of: in response to that a second terminal triggers alignment of the coordinate systems, obtaining, by the second terminal, map information stored in a cloud, or obtaining, by the second terminal, map information from a first terminal; and transforming, by the second terminal, a second coordinate system of the second terminal into an initial coordinate system corresponding to the map information stored in the cloud or into an initial coordinate system corresponding to the map information obtained from the first terminal, or transforming, by the second terminal, the initial coordinate system corresponding to the map information stored in the cloud or the initial coordinate system corresponding to the map information obtained from the first terminal into the second coordinate system of the second terminal. Each initial coordinate system is used for defining a positional relationship between the first terminal and the second terminal when respective map information is in a sharing state.

An aspect according to the embodiments of the disclosure provides a non-transitory computer-readable storage medium having stored thereon computer-readable instructions that, when executed by a processor, cause the processor to perform a method for aligning coordinate systems, the method including: in response to that a second terminal triggers alignment of the coordinate systems, obtaining, by the second terminal, map information stored in a cloud, or obtaining, by the second terminal, map information from a first terminal; and transforming, by the second terminal, a second coordinate system of the second terminal into an initial coordinate system corresponding to the map information stored in the cloud or into an initial coordinate system corresponding to the map information obtained from the first terminal, or transforming, by the second terminal, the initial coordinate system corresponding to the map information stored in the cloud or the initial coordinate system corresponding to the map information obtained from the first terminal into the second coordinate system of the second terminal. Each initial coordinate system is used for defining a positional relationship between the first terminal and the second terminal when respective map information is in a sharing state.

It is to be understood that the above general descriptions and detailed descriptions below are only exemplary and explanatory and not intended to limit the present disclosure.

Other features and aspects of the disclosure will be made clear by detailed descriptions of exemplary embodiments with reference to accompanying drawings below.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a method for aligning coordinate systems according to an embodiment of the disclosure.

FIG. 2 is a flowchart of a method for aligning coordinate systems according to an embodiment of the disclosure.

FIG. 3 is a flowchart of a method for aligning coordinate systems according to an embodiment of the disclosure.

FIG. 4 is a flowchart of a method for aligning coordinate systems according to an embodiment of the disclosure.

FIG. 5 is a schematic diagram of a process for uploading a map to a cloud in a method for aligning coordinate systems according to an embodiment of the disclosure.

FIG. 6 is a schematic diagram of alignment of coordinates in a first solution in a method for aligning coordinate systems according to an embodiment of the disclosure.

FIG. 7 is a schematic diagram of alignment of anchor points in a first solution in a method for aligning coordinate systems according to an embodiment of the disclosure.

FIG. 8 is a schematic diagram of alignment of coordinates in a second solution in a method for aligning coordinate systems according to an embodiment of the disclosure.

FIG. 9 is a schematic diagram of alignment of anchor points in a second solution of a method for aligning coordinate systems according to an embodiment of the disclosure.

FIG. 10 is a schematic diagram of alignment of coordinates in a third solution of a method for aligning coordinate systems according to an embodiment of the disclosure.

FIG. 11 is a block diagram of a device for aligning coordinate systems according to an embodiment of the disclosure.

FIG. 12 is a block diagram of an electronic device according to an embodiment of the disclosure.

FIG. 13 is a block diagram of an electronic device according to an embodiment of the disclosure.

### DETAILED DESCRIPTION

Various exemplary embodiments, features and aspects of the present disclosure are described in detail below with reference to the accompanying drawings. Elements with same functions or similar elements are represented by a same reference sign in an accompanying drawing. Although each aspect of the embodiments is illustrated in the accompanying drawing, the drawings do not have to be plotted to scale unless specifically indicated.

Herein the specific word “exemplary” means “used as an example or an embodiment, or descriptive”. Herein it is not necessary to explain that any embodiment described as “exemplary” is superior to or better than other embodiments.

The term “and/or” in the disclosure only represents an association relationship for describing associated objects, and may represent three relationships. For example, A and/or B may represent three conditions: i.e., only A, both A and B, and only B. In addition, herein the term “at least one” represents “any one of many” or “any combination of at least two of many”. For example, “including at least one of A, B or C” may represent that “selecting one or more elements from among a set composed of A, B and C”.

In addition, a great many details are given in the following detailed description to make the disclosure better described. Those skilled in the art should understand the disclosure is also able to be implemented in the absence of some details. In some examples, methods, means, elements and electric circuits familiar to those skilled in the art are not described in detail to make the main idea of the disclosure shown clearly.

With SLAM as an example, a problem to be solved by the SLAM can be described as: a robot begins to move from an unknown position in an unknown environment; during its movement, it localizes itself according to position estimation and a map, and establishes an incremental map based on self-localization, so as to enable the robot to implement autonomous localization and navigation.

A cloud sharing function is an important functional module in applications such as the Augmented Reality (AR) and the virtual reality, and serves as a basis for multi-user collaboration. With the AR cloud as an example, the AR cloud may connect single-point AR experiences in series and copy them into a real world for storing, showing and sharing AR information. Perhaps, the AR cloud is what a future world described in science fiction movies looks like. In addition, with the cloud sharing function, multiple terminals that are based on the SLAM technique may determine their respective poses with respect to each other to accomplish a collaborative task.

Alignment of coordinate systems is a necessity for the cloud sharing function. Each terminal device generates a local coordinate system when running an SLAM algorithm. A pose outputted by an SLAM system is one in the local coordinate system. If the pose is directly transmitted to another device, it is not able to be parsed and used. Therefore, the alignment of the coordinate systems is indispensable in the cloud sharing.

The disclosure uses the SLAM system in its examples and provides coordinate system alignment solutions based on the SLAM system. The coordinate system alignment solutions include following there solutions and may be used for aligning coordinate systems of different SLAM systems. The three solutions are respectively applied to system architectures for different application scenarios. Herein, a concept “anchor point” is defined for the ease of description. In an SLAM coordinate system, a three-dimensional (3D) point with a special meaning is referred to as an anchor point. With an AR application as an example, at least one AR effect is given by placing a 3D object or a 3D animation at a position of an anchor point.

In a first solution, a terminal determines an initial coordinate system and uploads generated map data to a cloud; all of the SLAM coordinate system(s) corresponding to at least one other terminal are aligned with an initial coordinate system corresponding to a cloud map, therefore at least one anchor point is also registered in the initial coordinate system.

In a second solution, a terminal determines an initial coordinate system and uploads generated map data to a cloud; at least one anchor point is registered in the initial coordinate system; the initial coordinate system is aligned with a local SLAM coordinate system of each terminal, and then coordinates of at least one anchor point are transformed into coordinates in each local SLAM coordinate system.

In a third solution, different terminals communicate with each other, and each terminal transmits information of its local coordinate system and information of the anchor points in the local coordinate system to other terminals; then each terminal aligns coordinate systems of other devices with its local SLAM coordinate system and registers the anchor points of these coordinate systems in its local coordinate system.

It should be pointed out that the registration of the anchor points may be direct setting of the anchor points in the existing coordinate systems, and transformation of the coordinates of the anchor points is not needed during the sharing.

The method for aligning the coordinate systems provided in the embodiment of the disclosure can be applied to scenarios including interactions between multiple terminals and the cloud, direct interactions between multiple terminals (that the cloud is not involved in). Any method that is able to align a first terminal and a second terminal with a same coordinate system falls within the scope of the disclosure. In response to that the second terminal triggers the alignment of the coordinate systems, the second terminal obtains map information stored in the cloud or obtains the map information from the first terminal. The second terminal transforms a second coordinate system of the second terminal into the initial coordinate system corresponding to the map information stored in the cloud or into the initial coordinate system corresponding to the map information obtained from the first terminal. Alternatively, the second terminal transforms the initial coordinate system corresponding to the map information stored in the cloud or the initial coordinate system corresponding to the map information obtained from the first terminal into the second coordinate system of the second terminal. The initial coordinate system is used for defining a positional relationship between the first terminal and the second terminal when the map information is in a sharing state. In this way, if multiple terminals move and localize themselves in a shared map, the multiple terminals can share a map (referred to as a shared map) in a same coordinate system, it is thus possible to lay a foundation for accurate localization of the terminals with each other.

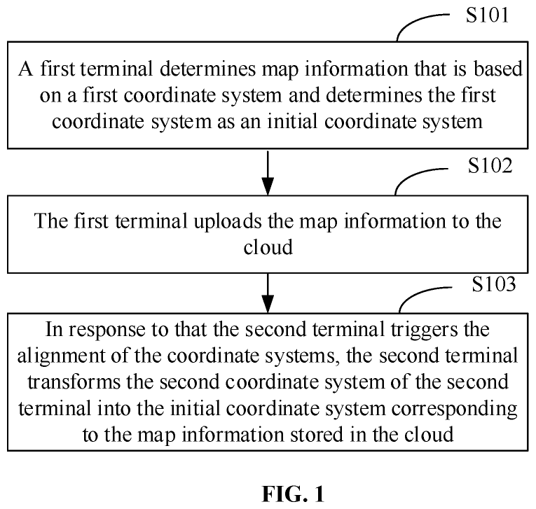

FIG. 1 is a flowchart of a method for aligning coordinate systems according to an embodiment of the disclosure. The method for aligning the coordinate systems is applied to a device for aligning the coordinate systems. For example, the device for aligning the coordinate systems may be operated by a terminal device, a server or other processing devices. The terminal device may be User Equipment (UE), a mobile device, a cellular phone, a cordless phone, a Personal Digital Assistant (PDA), a handheld device, a computing device, a vehicle-mounted device, a wearable device or the like. In some possible implementations, a processor may execute computer-readable instructions stored in a memory to perform the method for aligning the coordinate systems. As illustrated in FIG. 1, the method includes operations S101 to S103.

In operation S101, a first terminal determines map information that is based on a first coordinate system, and determines the first coordinate system as an initial coordinate system.

The initial coordinate system is used for defining a positional relationship between the first terminal and a second terminal when the map information is in a sharing state.

In operation S102, the first terminal uploads the map information to a cloud.

In operation S103, in response to that the second terminal triggers alignment of the coordinate systems, the second terminal transforms the second coordinate system of the second terminal into the initial coordinate system corresponding to the map information stored in the cloud.

Operation S103 may have two following possible implementations.

In a first implementation, the second terminal does not establish its coordinate system but directly determines the initial coordinate system as its own coordinate system after triggering the alignment of the coordinate systems. After triggering the alignment of the coordinate systems, the second terminal obtains the map information and anchor point information, and establishes map information that is based on its own second coordinate system according to the initial coordinate system. The second terminal sets the anchor point information in the map information that is based on the second coordinate system of the second terminal through interactive operations.

In a second implementation, the second terminal establishes its own coordinate system and then triggers the alignment processing of the coordinate systems. The second terminal triggers the alignment of the coordinate systems, obtains the map information, the anchor point information and a relative transformation relationship of the second terminal with respect to the first terminal in the initial coordinate system. The second terminal corrects its own second coordinate system according to the relative transformation relationship and establishes map information that is based on the corrected second coordinate system. Through interactive operations, the second terminal sets the anchor point information in the map information that is established after the second coordinate system is corrected.

In an example involving the SLAM, a terminal determines an initial coordinate system, uploads the map information generated by the first terminal to the cloud and aligns all SLAM coordinate system(s) corresponding to at least one other terminal with the initial coordinate system corresponding to the map information uploaded to the cloud; accordingly anchor points of the SLAM coordinate system(s) corresponding to at least one other terminal are registered in the initial coordinate system; in other words, the local SLAM coordinate systems are aligned with the SLAM coordinate system of the cloud. The registration of the anchor points is direct setting of the anchor points in the coordinate systems, and transformation of the coordinates of the anchor points is not needed during the sharing.

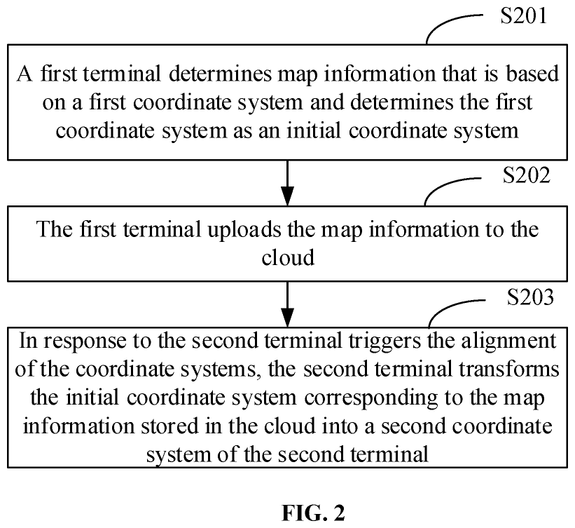

FIG. 2 is a flowchart of a method for aligning coordinate systems according to an embodiment of the disclosure. The method for aligning the coordinate systems is applied to a device for aligning the coordinate systems. For example, the device for aligning the coordinate systems may be operated by a terminal device, a server or other processing devices. The terminal device may be UE, a mobile device, a cellular phone, a cordless phone, a Personal Digital Assistant (PDA), a handheld device, a computing device, a vehicle-mounted device, a wearable device or the like. In some possible implementations, a processor may execute computer-readable instructions stored in a memory to perform the method for aligning the coordinate systems. As illustrated in FIG. 2, the method includes operations S201 to S203.

In operation S201, a first terminal determines map information that is based on a first coordinate system, and determines the first coordinate system as an initial coordinate system.

The initial coordinate system is used for defining a positional relationship between the first terminal and a second terminal when the map information is in a sharing state.

In operation S202, the first terminal uploads the map information to the cloud.

In operation S203, in response to the second terminal triggers the alignment of the coordinate systems, the second terminal transforms the initial coordinate system corresponding to the map information stored in the cloud into a second coordinate system of the second terminal.

Operation S203 may have a following possible implementation.

The second terminal triggers the alignment of the coordinate systems, aligns the initial coordinate system with the second coordinate system of the second terminal, and synchronously transforms the anchor information of the initial coordinate system into anchor information in the second coordinate system of the second terminal. Specifically, the second terminal triggers the alignment of the coordinate systems, and obtains a pose of the second terminal in its second coordinate system, the pose being provided by the second terminal; the second terminal obtains a pose of the second terminal in the initial coordinate system, the pose being determined by a localizing unit, and determines a relative transformation relation of a transformation from the initial coordinate system into the second coordinate system of the second terminal according to the two poses. Coordinate system transformation (the transformation of the initial coordinate system into the coordinate system based on the second terminal) is performed according to the relative transformation relationship, and the anchor point information in the initial coordinate system is synchronously transformed in the same transformation manner (using the same relative transformation relationship) into the information in the coordinate system that is based on the second terminal.

In an example involving the SLAM, a terminal determines an initial coordinate system and uploads the generated map information to the cloud; at least one anchor point is registered in the initial coordinate system; the initial coordinate system is aligned with a local SLAM coordinate system of each terminal; coordinates of the at least one anchor point in the initial coordinate system are respectively transformed into coordinates in each local SLAM coordinate system. In other words, in the above example, the SLAM coordinate system of the cloud is respectively aligned with the local SLAM coordinate systems. The registration of the anchor points is direct setting of the anchor points in the coordinate systems, and transformation of the coordinates of the anchor points is not needed during the sharing. However, only when the anchor points are shared are the coordinates of the anchor points transformed according to the relative transformation relationship between each coordinate system.

The localizing unit is configured to localize based on a shared map. In an example, local map data associated with at least one key frame is extracted from global map data, which includes the at least one key frame, of an image acquired by the first terminal; a current frame is obtained from an image acquired by the second terminal; feature matching is performed on the current frame and the local map data, and a localization result of the current frame is obtained according to a matching result; a positional relationship, which exists between the first terminal and the second terminal when the two terminals share the global map data, is obtained according to the localization result. The operation that the feature matching is performed on the current frame and the local map data, and the localization result of the current frame is obtained according to a matching result includes: 2D feature matching of feature points is performed to match the current frame with the at least one key frame in the local map data to obtain 2D feature matching results; 2D feature matching results including 3D information are screened from among the 2D feature matching results, and the 3D information is extracted from the screened 2D feature matching results; a pose for the current frame is obtained according to the 3D information and determined as the localization result. Specifically speaking, after the feature-point-2D-to-2D feature matching is performed, the 2D feature matching results including the 3D information (abbreviated as screened results) may be screened, and the pose for the current frame may be obtained according to the selecting results.

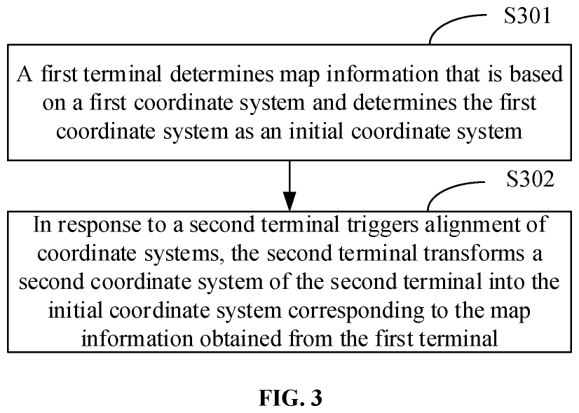

FIG. 3 is a flowchart of a method for aligning coordinate systems according to an embodiment of the disclosure. The method for aligning the coordinate systems is applied to a device for aligning the coordinate systems. For example, the device for aligning the coordinate systems may be operated by a terminal device, a server or other processing devices. The terminal device may be UE, a mobile device, a cellular phone, a cordless phone, a PDA, a handheld device, a computing device, a vehicle-mounted device, a wearable device or the like. In some possible implementations, a processor may execute computer-readable instructions stored in a memory to perform the method for aligning the coordinate systems. As illustrated in FIG. 3, the method includes operations S301 to S302.

In operation S301, a first terminal determines map information that is based on a first coordinate system and determines the first coordinate system as an initial coordinate system.

The initial coordinate system is used for defining a positional relationship between the first terminal and a second terminal when the map information is in a sharing state.

In operation S302, in response to the second terminal triggers the alignment of the coordinate systems, the second terminal transforms a second coordinate system of the second terminal into the initial coordinate system corresponding to the map information obtained from the first terminal.

The embodiment of the disclosure does not involve interactions between the terminals and a cloud, instead, interconnection and communication is made between multiple terminals independent of the cloud. Operation S302 may have two following possible implementations:

The first implementation: the second terminal does not establish its coordinate system but directly determines the initial coordinate system as its own coordinate system after triggering the alignment of the coordinate systems. After triggering the alignment of the coordinate systems, the second terminal obtains the map information and anchor point information, and establishes map information that is based on its own second coordinate system according to the initial coordinate system. The second terminal sets the anchor point information in the map information that is based on the second coordinate system of the second terminal through interactive operations.

The second implementation: the second terminal establishes its own coordinate system and then triggers the alignment processing of the coordinate systems. The second terminal triggers the alignment of the coordinate systems, obtains the map information, the anchor point information and a relative transformation relationship of the second terminal with respect to the first terminal in the initial coordinate system. The second terminal corrects its own second coordinate system according to the relative transformation relationship and establishes map information that is based on the corrected second coordinate system. Through interactive operations, the second terminal sets the anchor point information in the map information that is established after the second coordinate system is corrected.

In an example involving the SLAM: a terminal determines an initial coordinate system, uploads the map information generated by the first terminal to the cloud and aligns all SLAM coordinate system(s) corresponding to at least one other terminal with the initial coordinate system corresponding to the map information stored in the cloud; accordingly anchor points of the SLAM coordinate system(s) corresponding to at least one other terminal are registered in the initial coordinate system; in other words, the local SLAM coordinate systems are aligned with the SLAM coordinate system of the cloud. The registration of the anchor points is direct setting of the anchor points in the coordinate systems, and transformation of the coordinates of the anchor points is not needed during the sharing.

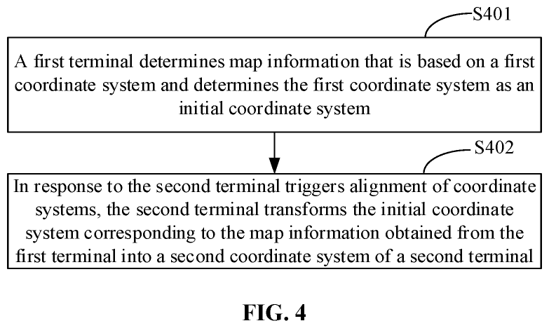

FIG. 4 is a flowchart of a method for aligning coordinate systems according to an embodiment of the disclosure. The method for aligning the coordinate systems is applied to a device for aligning the coordinate systems. For example, the device for aligning the coordinate systems may be operated by a terminal device, a server or other processing devices. The terminal device may be UE, a mobile device, a cellular phone, a cordless phone, a PDA, a handheld device, a computing device, a vehicle-mounted device, a wearable device or the like. In some possible implementations, a processor may execute computer-readable instructions stored in a memory to perform the method for aligning the coordinate systems. As illustrated in FIG. 4, the method includes operations S401 to S402.

In operation 401, a first terminal determines map information that is based on a first coordinate system, and determines the first coordinate system as an initial coordinate system.

When the map information is in a sharing state, the initial coordinate system is used for defining a positional relationship between the first terminal and a second terminal.

In operation 402, in response to the second terminal triggers the alignment of the coordinate systems, the second terminal transforms the initial coordinate system corresponding to the map information obtained from the first terminal into a second coordinate system of the second terminal.

The embodiment of the disclosure does not involve interactions between the terminals and a cloud, instead, interconnection and communication is made between multiple terminals independent of the cloud. Operation 402 may have a following implementation.

The second terminal triggers the alignment of the coordinate systems, aligns the initial coordinate system with the second coordinate system of the second terminal, and synchronously transforms the anchor information of the initial coordinate system into anchor information in the second coordinate system of the second terminal. Specifically, the second terminal triggers the alignment of the coordinate systems, and obtains a pose of the second terminal in its second coordinate system, the pose being provided by the second terminal; the second terminal obtains a pose of the second terminal in the initial coordinate system, the pose being determined by a localizing unit, and determines a relative transformation relation of a transformation from the initial coordinate system into the second coordinate system of the second terminal according to the two poses. Coordinate system transformation (the transformation of the initial coordinate system into the coordinate system based on the second terminal) is performed according to the relative transformation relationship, and the anchor point information in the initial coordinate system is synchronously transformed in the same transformation manner (using the same relative transformation relationship) into the information in the coordinate system that is based on the second terminal.

In an example involving the SLAM: a terminal determines an initial coordinate system and uploads the generated map information to the cloud; at least one anchor point is registered in the initial coordinate system; the initial coordinate system is aligned with a local SLAM coordinate system of each terminal; coordinates of the at least one anchor point in the initial coordinate system are respectively transformed into coordinates in each local SLAM coordinate system. In other words, in the above example, the SLAM coordinate system of the cloud is respectively aligned with the local SLAM coordinate systems. The registration of the anchor points is direct setting of the anchor points in the coordinate systems, and transformation of the coordinates of the anchor points is not needed during the sharing. However, only when the anchor points are shared are the coordinates of the anchor points transformed according to the relative transformation relationship between each coordinate system.

It is should be pointed out that an SLAM system only serves as an example and the disclosure is not limited to the vision-based SLAM system and visual SLAM algorithms. The above embodiments are not limited to one specific architecture but are suitable for and commonly used in various system architectures.

According to the embodiment of the disclosure, the method for aligning the coordinate systems includes following operations: the first terminal determines the map information that is based on the first coordinate system and determines the first coordinate system as the initial coordinate system, herein when the map information is in the sharing state, the initial coordinate system is used for defining the positional relationship between the first terminal and the second terminal; the first terminal uploads the map information to the cloud. Accordingly, in response to the second terminal triggers the alignment of the coordinate systems, the second terminal obtains the map information stored in the cloud. The second terminal transforms its own second coordinate system into the initial coordinate system corresponding to the map information stored in the cloud. When the map information is in the sharing state, the initial coordinate system is used for defining the positional relationship between the first terminal and a second terminal.

In a possible implementation of the disclosure, the operation that the first terminal determines the map information that is based on the first coordinate system includes following operations: the first terminal acquires images from a target scenario based on the first coordinate system to obtain an image acquiring result; the first terminal obtains the map information according to the image acquiring result.

In a possible implementation of the disclosure, the operation that the second terminal transforms its own second coordinate system into the initial coordinate system corresponding to the map information stored in the cloud includes following operations: the second terminal establishes its own second coordinate system according to the initial coordinate system to base the second coordinate system on the initial coordinate system; the second terminal establishes, according to the map information stored in the cloud, map information that is based on the second coordinate system of the second terminal.

In a possible implementation of the disclosure, the method further includes a following operation: through interactive operations, the second terminal sets the anchor information in the map information that is based on the second coordinate system of the second terminal.

In a possible implementation of the disclosure, the operation that the second terminal transforms its own second coordinate system into the initial coordinate system corresponding to the map information stored in the cloud includes following operations: the second terminal obtains the relative transformation relationship of the second terminal with respect to the first terminal in the initial coordinate system; the second terminal corrects the second coordinate system of the second terminal according to the relative transformation relationship so that the corrected second coordinate system is based on the initial coordinate system; according to the map information stored in the cloud, the second terminal establishes the map information that is based on the corrected second coordinate system of the second terminal.

In a possible implementation of the disclosure, the method further includes a following operation: through the interactive operations, the second terminal sets the anchor information in the map information that is based on the corrected second coordinate system of the second terminal.

According to the embodiment of the disclosure, the method for aligning the coordinate systems includes following operations: the first terminal determines the map information that is based on the first coordinate system and determines the first coordinate system as the initial coordinate system, herein when the map information is in the sharing state, the initial coordinate system is used for defining the positional relationship between the first terminal and the second terminal; the first terminal uploads the map information to the cloud. Accordingly, in response to the second terminal triggers the alignment of the coordinate systems, the second terminal obtains the map information stored in the cloud and transforms the initial coordinate system corresponding to the map information stored in the cloud into the second coordinate system of the second terminal. When the map information is in the sharing state, the initial coordinate system is used for defining the positional relationship between the first terminal and a second terminal.

In a possible implementation of the disclosure, the operation that the first terminal determines the map information that is based on the first coordinate system includes following operations: the first terminal acquires images from the target scenario based on the first coordinate system to obtain the image acquiring result; the first terminal obtains the map information according to the image acquiring result.

In a possible implementation of the disclosure, the operation that the second terminal transforms the initial coordinate system corresponding to the map information stored in the cloud into the second coordinate system of the second terminal includes following operations: the second terminal corrects the initial coordinate system according to a relative transformation relationship between poses of the second terminal in different coordinate systems so that the corrected initial coordinate system is based on the second coordinate system of the second terminal; according to the map information stored in the cloud, the second terminal establishes map information that is based on the corrected initial coordinate system.

In a possible implementation of the disclosure, the coordinates of the anchor points are subjected to the same transformation as the one performed on the coordinate systems, which means the coordinates of the anchor points are synchronously transformed into coordinates in the coordinate system of the second terminal according to the relative transformation relationship. Specifically speaking, according to the relative transformation relationship, the second terminal synchronizes the anchor point information in the initial coordinate system with the map information that is based on the corrected initial coordinate system.

In a possible implementation of the disclosure, the method further includes following operations: a first pose of the second terminal in the initial coordinate system (calculated by the localizing unit) is obtained; a second pose of the second terminal in the second coordinate system of the second terminal (provided by the second terminal) is obtained; the relative transformation relationship is obtained according to the first pose and the second pose. The relative transformation relationship is used for representing a relative transformation relationship of a transformation from the initial coordinate system into the second coordinate system of the second terminal.

According to the embodiment of the disclosure, the method for aligning the coordinate systems includes following operations: the first terminal determines the map information that is based on the first coordinate system and determines the first coordinate system as the initial coordinate system, herein when the map information is in the sharing state, the initial coordinate system is used for defining the positional relationship between the first terminal and the second terminal; the first terminal uploads the map information to the cloud. Accordingly, in response to that the second terminal triggers the alignment of the coordinate system, the second terminal obtains the map information from the first terminal; the second terminal transforms its own second coordinate system into the initial coordinate system corresponding to the map information obtained from the first terminal. The initial coordinate system is used for defining the positional relationship between the first terminal and the second terminal.

In a possible implementation of the disclosure, the operation that the first terminal determines the map information that is based on the first coordinate system includes following operations: the first terminal acquires images from the target scenario based on the first coordinate system to obtain the image acquiring result; the first terminal obtains the map information according to the image acquiring result.

In a possible implementation of the disclosure, the operation that the second terminal transforms its second coordinate system into the initial coordinate system corresponding to the map information obtained from the first terminal includes following operations: the second terminal establishes its own second coordinate system according to the initial coordinate system to base the second coordinate system on the initial coordinate system; the second terminal establishes map information that is based on the second coordinate system of the second terminal according to the map information obtained from the first terminal.

In a possible implementation of the disclosure, the method further includes a following operation: through interactive operations, the second terminal sets the anchor information in the map information that is based on the second coordinate system of the second terminal.

In a possible implementation of the disclosure, the operation that the second terminal transforms its own second coordinate system into the initial coordinate system corresponding to the map information obtained from the first terminal includes following operations: the second terminal obtains the relative transformation relationship of the second terminal with respect to the first terminal in the initial coordinate system; the second terminal corrects the second coordinate system of the second terminal according to the relative transformation relationship to base the corrected second coordinate system on the initial coordinate system; according to the map information obtained from the first terminal, the second terminal establishes map information that is based on the corrected second coordinate system of the second terminal.

In a possible implementation of the disclosure, the method further includes a following operation: through the interactive operations, the second terminal sets the anchor information in the map information that is based on the corrected second coordinate system of the second terminal.

According to the embodiment of the disclosure, the method for aligning the coordinate systems includes following operations: the first terminal determines the map information that is based on the first coordinate system and determines the first coordinate system as the initial coordinate system, herein when the map information is in the sharing state, the initial coordinate system is used for defining the positional relationship between the first terminal and the second terminal; the first terminal uploads the map information to the cloud. Accordingly, in response to the second terminal triggers the alignment of the coordinate systems, the second terminal obtains the map information from the first terminal; the second terminal transforms the initial coordinate system corresponding to the map information obtained from the first terminal into the second coordinate system of the second terminal. When the map information is in the sharing state, the initial coordinate system is used for defining the positional relationship between the first terminal and the second terminal.

In a possible implementation of the disclosure, the operation that the first terminal determines the map information that is based on the first coordinate system includes following operations: the first terminal acquires images from the target scenario based on the first coordinate system to obtain the image acquiring result; the first terminal obtains the map information according to the image acquiring result.

In a possible implementation of the disclosure, the operation that the second terminal transforms the initial coordinate system corresponding to the map information obtained from the first terminal into the second coordinate system of the second terminal includes following operations: the second terminal corrects the initial coordinate system according to the relative transformation relationship between the poses of the second terminal in different coordinate systems so that the corrected initial coordinate system is based on the second coordinate system of the second terminal, herein the relative transformation relationship includes a relative transformation relationship of the transformation from the initial coordinate system into the second coordinate system of the second terminal; according to the map information obtained from the first terminal, the second terminal establishes map information that is based on the corrected initial coordinate system.

In a possible implementation of the disclosure, the method further includes a following operation: according to the relative transformation relationship, the second terminal synchronizes the anchor point information in the initial coordinate system with the map information that is based on the corrected initial coordinate system.

In a possible implementation of the disclosure, the method further includes a following operation: the first pose of the second terminal in the initial coordinate system (calculated by a localizing module) is obtained; the second pose of the second terminal in the second coordinate system of the second terminal (provided by the second terminal) is obtained; the relative transformation relationship is obtained according to the first pose and the second pose.

### APPLICATION EXAMPLES

Three solutions for performing coordinate system transformation according to the disclosure are as follows. A first solution (that aligns a local coordinate system with a cloud coordinate system) does not involve transformation of coordinates of anchor points but the coordinate system transformation. In the first solution, the anchor points are registered automatically, and only setting of the anchor points is needed. The first solution provides two alternatives. The first one is that a second terminal does not establish its coordinate system but directly determines an initial coordinate system as its own coordinate system after triggering alignment of the coordinate systems. The second one is that the second terminal establishes its own coordinate system and then triggers alignment processing of the coordinate systems. A second solution (that aligns the cloud coordinate system with the local coordinate system) relates to a synchronous transformation of the coordinate system and the coordinates of the anchor points. In a third solution, interconnection and communication is made between the terminals. The third solution is different from the first and the second solutions (where the communication between the terminals is implemented through a central server in the cloud). The third solution may include a part of the first solution or a part of the second solution.

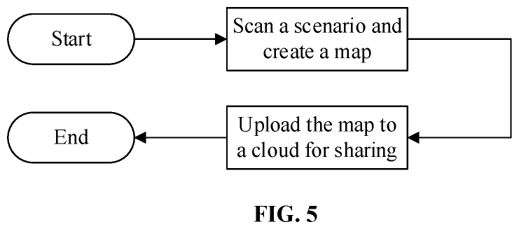

In both the first and the second solution, a terminal device needs to establish the initial coordinate system, and uploads map information in the coordinate system to the cloud. This process has no differences between the first solution and the second solution, which is illustrated in FIG. 5.

FIG. 5 is a schematic diagram of a process for uploading a map to a cloud in a method for aligning coordinate systems according to an embodiment of the disclosure. The process includes: a terminal device scans a scenario, constructs map information according to the scanned scenario and uploads the map information to the cloud to make the information shared by multiple terminals. An algorithm and map data for constructing the map information may have different alternatives. The data may be a sparse point cloud constructed based on visual sparse SLAM, a dense point cloud reconstructed by a dense SLAM algorithm, or a point cloud map acquired by for example a radar device through a non-visual algorithm.

The three solutions are respectively introduced as follows.

First Solution

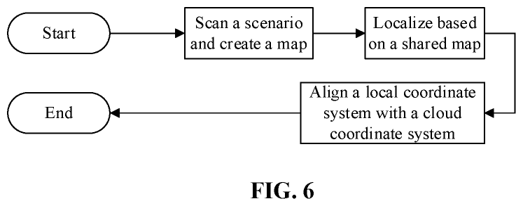

FIG. 6 is a schematic diagram of alignment of coordinates in the first solution in a method for aligning coordinate systems according to an embodiment of the disclosure. The first solution is described as follows.

In operation 1, a terminal device scans a scenario to generate map information. There are different alternatives for this operation, which are determined depending on devices or SLAM schemes involved. Usually, a visual scheme needs at least one piece of key frame information, whereas constituent elements of a map required by a non-visual scheme have to at least meet a minimum data requirement for execution of a corresponding localization algorithm. The minimum data requirement is configured according to a size of the data that are required in the execution of the localization algorithm.

In operation 2, a localization pose [R_{c} t_{c}] is obtained through localization performed based on a shared map. The localization is performed according to the local map information obtained from operation 1 and according to the map information uploaded to the cloud in the process in FIG. 5. Likewise, the localization algorithm is determined depending on the adopted SLAM scheme. A vision-based scheme usually involves feature matching that establishes matching of 2D with 3D to estimate the pose. There are also localization methods that directly estimate the pose based on deep learning. For non-visual SLAM scheme, there are localization solutions differing from each other a lot. For example, a localization solution based on a point cloud usually uses an Iterative Closest Point (ICP) algorithm to solve (in short, the ICP algorithm keeps searching for closest points in an iterative way, and defines a threshold to implement splicing of multiple views finally).

In operation 3, the local coordinate system can be aligned with the cloud coordinate system using the localization pose [R_{c} t_{c}] obtained from operation 2 in combination with a pose [Rₗ tₗ] in the local coordinate system, which is already included in operation 1. Herein, R_{c} is a rotational matrix that represents an orientation of a second device in a cloud coordinate system, and t_{c} is a 3D vector that represents a position of the second device in the cloud coordinate system; and Rₗ is a rotational matrix that represents an orientation of the second device in the local coordinate system, and tₗ is a 3D vector that represents a position of the second device in the local coordinate system. If it is assumed that after the alignment, a point Xₗ in the local coordinate system corresponds to a point X_{c} in the cloud coordinate system, a relative transformation [dR dt] between the two coordinate systems can be defined, where dR is a rotational matrix and dt is a 3D vector, both of which constitute a transformation matrix that is used to align the cloud coordinate system with the local coordinate system. A formula (1) for the alignment is defined in detail as:

X_{c}=dR*Xₗ+dt (1).

[dR dt] may be solved for through a formula (2) and a formula (3):

dR=R_{c}^{T}*Rₗ (2); and

dt=R_{c}^{T}*(tₗ−t_{c}) (3).

A first device scans the scenario, uploads the map information to the cloud and applies this relative transformation [dR dt] to a coordinate system of the second device, thus completing alignment of the coordinate system of the second device with a coordinate system of the first device. Particularly, if the coordinate system of the second device is not established, initialization may be performed by directly using the localization pose [R_{c} t_{c}]; herein, Rₗ=R_{c}, tₗ=t_{c}, dR=I and dt=\vec{0}, where l represents a unit matrix.

In the above formulas, X_{c} is a point in the cloud coordinate system, Xₗ is a point in the local coordinate system and R_{c}^{T} is a transpose of R_{c}.

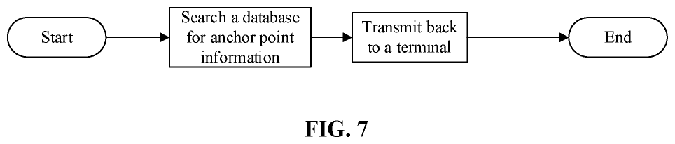

After the alignment of the coordinate systems is completed, alignment of the anchor points remains to be done as illustrated in FIG. 7. FIG. 7 is a schematic diagram of alignment of anchor points in the first solution in a method for aligning coordinate systems according to an embodiment of the disclosure. The alignment of anchor points includes: a database is searched for anchor points, and the anchor points that are obtained after the search are transmitted back to a terminal. Since at least one terminal is aligned with a cloud coordinate system and the anchor points also lie in the cloud coordinate system, other transformations of coordinates of the anchor points are no longer needed in sharing of the anchor points.

Second Solution

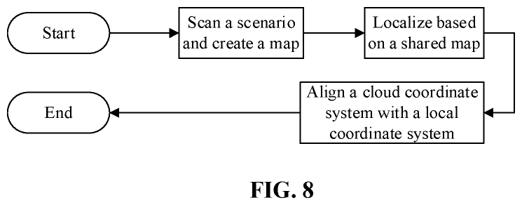

FIG. 8 is a schematic diagram of alignment of coordinates in the second solution in a method for aligning coordinate systems according to an embodiment of the disclosure.

In operation 1, a terminal device scans a scenario to generate map information. There are different alternatives for this operation, which are determined depending on devices or SLAM schemes involved. Usually, a visual scheme needs at least one piece of key frame information, whereas constituent elements of a map required by a non-visual scheme have to at least meet a minimum data requirement for execution of a corresponding localization algorithm, and include a pose [Rₗ tₗ] for a current frame.

In operation 2, a localization pose [R_{c} t_{c}] is obtained through the localization that is performed based on a shared map, where R_{c} is a rotational matrix that represents an orientation of a second device in a cloud coordinate system and t_{c} is a 3D vector that represents a position of the second device in the cloud coordinate system. The localization is performed according to the local map information obtained from operation 1 and according to the map information uploaded to the cloud in the process in FIG. 5. Likewise, the localization algorithm is determined depending on the adopted SLAM scheme. A vision-based scheme usually involves feature matching that establishes matching of 2D with 3D to estimate the pose. There are also localization methods that directly estimate the pose based on deep learning. For non-visual SLAM scheme, there are localization solutions differing from each other a lot. For example, a localization solution based on a point cloud usually uses an Iterative Closest Point (ICP) algorithm to solve (in short, the ICP algorithm keeps searching for closest points in an iterative way, and defines a threshold to implement splicing of multiple views finally).

In operation 3, the cloud coordinate system is aligned with the local coordinate system using the localization pose [R_{c} t_{c}] obtained from operation 2 In combination with a pose [Rₗ tₗ] in the local coordinate system already included in operation 1 (where Rₗ is a rotational matrix that represents an orientation of the second device in a local coordinate system and tₗ is a 3D vector that represents a position of the second device in the local coordinate system). If it is assumed that after the alignment, a point X_{c} in the cloud coordinate system corresponds to a point Xₗ in the local coordinate system, a relative transformation [dR dt] between the two coordinate systems may be defined, where dR is a rotational matrix and dt is a 3D vector, both of which constitute a transformation matrix that is used to align the local coordinate system with the cloud coordinate system. A formula (4) for the alignment is defined in detail as:

Xₗ=dR*X_{c}+dt (4).

[dR dt] may be solved for through a formula (5) and a formula (6):

dR=Rₗ^{T}*R_{c} (5); and

dt=Rₗ^{T}*(t_{c}−tₗ) (6).

In the above formulas, X_{c} is a point in the cloud coordinate system, X_{I} is a point in the local coordinate system and Rₗ^{T} is a transpose of R₁.

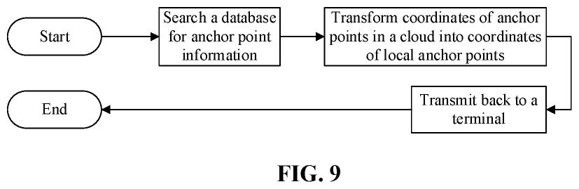

After the alignment of the coordinate systems is completed, alignment of the anchor points remains to be done as illustrated in FIG. 9. FIG. 9 is a schematic diagram of alignment of the anchor points in the second solution in a method for aligning coordinate systems according to an embodiment of the disclosure. The alignment of the anchor points includes following operations.

In operation 1, anchor data that are saved earlier are searched for.

In operation 2, since anchor points that are found out in the search are saved earlier according to a cloud coordinate system, a transformation formula that is obtained according to FIG. 8 to align the cloud coordinate system with a local coordinate system is needed to be used to transform coordinates of the anchor points in the cloud into coordinates in the local coordinate system in a same manner.

In operation 3, after being aligned, the anchor points are transmitted back to the terminal. If it is assumed that a pose of an anchor point in the cloud coordinate system is [R_{ac} t_{ad}], where R_{ac} is a rotational matrix representing an orientation of the anchor point in the cloud coordinate system and t_{ac} is a 3D vector representing a position of the anchor point in the cloud coordinate system, then a pose of the anchor point that is aligned with the local coordinate system is [Rₐₗ tₐₗ], where Rₐₗ is a rotational matrix representing an orientation of the anchor point in the local coordinate system and tₐₗ is a 3D vector representing a position of the anchor point in the local coordinate system. The corresponding transformation formulas include a formula (7) and a formula (8):

Rₐₗ=dR*Rₐₗ (7); and

tₐₗ=dR*t_{ac}+dt (8).

Third Solution

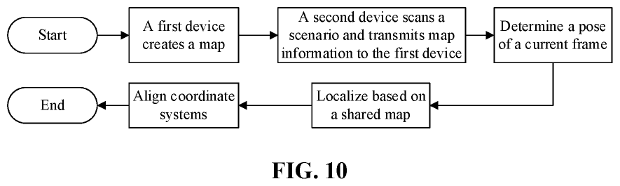

The third solution is different from the first and the second solutions because it does not rely on a cloud architecture but makes use of interconnection between terminals to align coordinate systems. The third solution is illustrated in FIG. 10. FIG. 10 is a schematic diagram of alignment of coordinates in the third solution in a method for aligning coordinate systems according to an embodiment of the disclosure. The third solution includes following operations.

In operation 1, a first device creates a map that does not have to be uploaded.

In operation 2, other devices scan a scenario and transmit map information to the first device. A requirement for the map information in the third solution is same as one for the map information in any of the first and the second solutions, that is to say, the map information should include minimum amount of map data that is needed for localization. The map information may be transmitted through many means such as blue tooth, a Local Area Network (LAN) and the like.

In operation 3, a localization pose [R_{c} t_{c}] is obtained through the localization that is performed based on the shared map, where R_{c} is rotational matrix representing an orientation of a second device in the cloud coordinate system and t_{c} is a 3D vector representing a position of the second device in the cloud coordinate system. The localization is performed according to the local map information obtained from operation 1 and according to the map information uploaded to the cloud in the process in FIG. 5. Likewise, the localization algorithm is determined depending on the adopted SLAM scheme. A vision-based scheme usually involves feature matching that establishes matching of 2D with 3D to estimate the pose. There are also localization methods that directly estimate the pose based on deep learning. For non-visual SLAM scheme, there are localization solutions differing from each other a lot. For example, a localization solution based on a point cloud usually uses an Iterative Closest Point (ICP) algorithm to solve (in short, the ICP algorithm keeps searching for closest points in an iterative way, and defines a threshold to implement splicing of multiple views finally).

In operation 4, the coordinate systems are aligned. Either operation 3 in the first solution or operation 3 in the second solution may be used as the alignment solution. The foregoing descriptions can be referred to for the alignment solution that will not be elaborated herein.

Both the first and the second solutions may be applied to a system architecture with a central server. In the two solutions, a shared map is stored in a cloud. In the first solution, a whole transformation is performed on a local coordinate system, which may adversely affect execution of a local SLAM algorithm. The first solution is applicable to a system where a local SLAM system can synchronize the whole transformation at a small cost, or to an architecture in which cloud data have to be downloaded to a local location for being parsed. The second solution needs to perform coordinate system transformation when synchronizing each piece of anchor point information, which introduces some additional computing work. However, usually the amount of the additional computing work is negligibly small.

No longer depending on the central server, the third solution does not have to upload data to the cloud and is suitable for a system architecture in which terminal devices can directly connect with each other.

In a scenario where a solution of the disclosure is used, a first player may scan the scenario, add an AR effect that he likes into the scenario (for example, he draws a smiling face), upload a map and share the map with his buddy that is referred to as a second player. In the same scenario, the second player can see the smiling face drawn by the first player after a coordinate system for the first player is aligned with a coordinate system for the second player. The second play can also draw another smiling face beside the one drawn by the first player, and then the second smiling face will be synchronized to a terminal of the first player. The map can also be shared with more terminal devices.

Those skilled in the art may understand that in the above methods in the detailed descriptions, an order in which all operations are written does not mean a strict order in which they are performed and do not bring any limitation on their implementation processes. The order in which the operations are performed should be determined by their functions and possible internal logics.

It can be understood that all above the method embodiments of the disclosure may combine with each other to form a combined embodiment without departing from the principles and the logics. Due to a limited space, the details will not be given in the disclosure.

In addition, a device for aligning coordinate systems, an electronic device, a computer-readable storage medium and a program, which all may be used to implement any of the methods for aligning the coordinate systems provided in the disclosure, are also provided in the embodiments of the disclosure. The descriptions of their corresponding methods should be referred to for their corresponding technical solutions, descriptions. Details will not be repeated herein.

The device for aligning the coordinate systems provided in the embodiment of the disclosure may be located at a terminal and can be applied to scenarios including interactions between multiple terminals and the cloud, direct interactions between multiple terminals (in which the cloud is not involved). Any device that may align a first terminal and a second terminal with a same coordinate system falls within the scope of the disclosure. The device includes an obtaining unit and an aligning unit. The obtaining unit is configured to, in response to that a second terminal triggers alignment of the coordinate systems, obtain map information stored in a cloud or obtain the map information from a first terminal. The aligning unit is configured to be used by the second terminal to transform a second coordinate system of the second terminal into an initial coordinate system corresponding to the map information stored in the cloud or into the initial coordinate system corresponding to the map information obtained from the first terminal or transform the initial coordinate system corresponding to the map information stored in the cloud or the initial coordinate system corresponding to the map information obtained from the first terminal into the second coordinate system of the second terminal. The initial coordinate system is used for defining a positional relationship between the first terminal and the second terminal when the map information is in a sharing state. In this way, if multiple terminals move and localize themselves in a shared map, the multiple terminals can share a map (referred to as a shared map) in a same coordinate system, it is thus possible to lay a foundation for accurate localization of the terminals with each other.

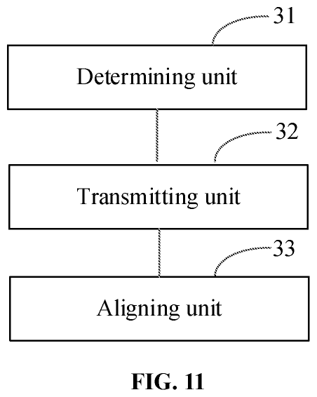

FIG. 11 is a block diagram of a device for aligning coordinate systems according to an embodiment of the disclosure. As illustrated in FIG. 11, the device for aligning the coordinate systems includes a determining unit 31, a transmitting unit 32 and an aligning unit 33. The determining unit 31 is configured to determine map information that is based on a first coordinate system and take the first coordinate system as an initial coordinate system. The initial coordinate system is used for defining a positional relationship between a first terminal and a second terminal when the map information is in a sharing state. The transmitting unit 32 is configured to upload the map information to a cloud. The aligning unit 33 is configured to transform a second coordinate system of the second terminal into the initial coordinate system corresponding to map information stored in the cloud in response to that the alignment of the coordinate systems is triggered.

In a possible implementation of the disclosure, the device includes a determining unit, a transmitting unit and an aligning unit. The determining unit is configured to determine the map information that is based on the first coordinate system and determine the first coordinate system as the initial coordinate system. The initial coordinate system is used for defining the positional relationship between the first terminal and the second terminal when the map information is in the sharing state. The transmitting unit is configured to upload the map information to the cloud. The aligning unit is configured to transform the initial coordinate system corresponding to map information stored in the cloud into the second coordinate system of the second terminal in response to that the alignment of the coordinate systems is triggered.

According to the embodiment of the disclosure, the device for aligning the coordinate systems includes the determining unit and the aligning unit. The determining unit is configured to determine the map information that is based on the first coordinate system and determine the first coordinate system as the initial coordinate system. The initial coordinate system is used for defining the positional relationship between the first terminal and the second terminal when the map information is in the sharing state. The aligning unit is configured to transform the second coordinate system of the second terminal into the initial coordinate system corresponding to the map information obtained from the first terminal in response to that the alignment of the coordinate systems is triggered.

According to the embodiment of the disclosure, the device for aligning the coordinate systems includes the determining unit and the aligning unit. The determining unit is configured to determine the map information that is based on the first coordinate system and determine the first coordinate system as the initial coordinate system. The initial coordinate system is used for defining the positional relationship between the first terminal and the second terminal when the map information is in the sharing state. The aligning unit is configured to transform the initial coordinate system corresponding to the map information obtained from the first terminal into the second coordinate system of the second terminal in response to that the alignment of the coordinate systems is triggered.

According to the embodiment of the disclosure, the device for aligning the coordinate systems includes the determining unit and the transmitting unit. The determining unit is configured to determine the map information that is based on the first coordinate system and determine the first coordinate system as the initial coordinate system. The initial coordinate system is used for defining the positional relationship between the first terminal and the second terminal when the map information is in the sharing state. The transmitting unit is configured to upload the map information to the cloud.

In a possible implementation of the disclosure, the determining unit is further configured to: acquire images from a target scenario based on the first coordinate system to obtain the image acquiring result and obtain the map information according to the image acquiring result.

According to the embodiment of the disclosure, the device for aligning the coordinate systems includes an obtaining unit and the aligning unit. The obtaining unit is configured to obtain the map information stored in the cloud in response to the alignment of the coordinate systems is triggered. The aligning unit is configured to transform the second coordinate system of the second terminal into the initial coordinate system corresponding to the map information stored in the cloud. The initial coordinate system is used for defining the positional relationship between the first terminal and the second terminal when the map information is in the sharing state.

In a possible implementation of the disclosure, the alignment unit is further configured to: establish the second coordinate system of the second terminal according to the initial coordinate system; and establish map information that is based on the second coordinate system of the second terminal

In a possible implementation of the disclosure, the device further includes: an anchor point setting unit that is configured to set anchor point information in the map information of the second coordinate system of the second terminal through interactive operations.

In a possible implementation of the disclosure, the aligning unit is further configured to: obtain a relative transformation relationship of the second terminal with respect to the first terminal in the initial coordinate system; correct the second coordinate system of the second terminal according to the relative transformation relationship; and establish, according to the map information stored in the cloud, map information that is based on the corrected second coordinate system of the second terminal.

In a possible implementation of the disclosure, the device further includes: the anchor point setting unit that is configured to set the anchor point information in the map information of the second coordinate system of the second terminal through interactive operations.

According to the embodiment of the disclosure, the device for aligning the coordinate systems includes the obtaining unit and the aligning unit. The obtaining unit is configured to obtain the map information stored in the cloud in response to that the alignment of the coordinate systems is triggered. The aligning unit is configured to transform the initial coordinate system corresponding to the map information stored in the cloud into the second coordinate system of the second terminal. The initial coordinate system is used for defining the positional relationship between the first terminal and the second terminal when the map information is in the sharing state.

In a possible implementation of the disclosure, the aligning unit is further configured to: correct the initial coordinate system according to a relative transformation relationship between poses of the second terminal in different coordinate systems; and establish, according to the map information stored in the cloud, map information that is based on the corrected initial coordinate system.

In a possible implementation of the disclosure, the device further includes: an anchor point transformation unit that is configured to synchronize the anchor point information in the initial coordinate system with the map information, which is based on the corrected initial coordinate system, according to the relative transformation relationship.

In a possible implementation of the disclosure, the device further includes a first pose acquisition unit, a second pose acquisition unit and a processing unit. The first pose acquisition unit is configured to obtain a first pose of the second terminal in the initial coordinate system. The second pose acquisition unit is configured to obtain a second pose of the second terminal in the second coordinate system of the second terminal. The processing unit is configured to obtain the relative transformation relationship according to the first pose and the second pose. The relative transformation relationship is used for representing a relative transformation relationship of a transformation from the initial coordinate system into the second coordinate system of the second terminal.

According to the embodiment of the disclosure, the device for aligning the coordinate systems includes the obtaining unit and the aligning unit. The obtaining unit is configured to obtain the map information from the first terminal in response to that the alignment of the coordinate systems is triggered. The aligning unit is configured to transform the second coordinate system of the second terminal into the initial coordinate system corresponding to the map information obtained from the first terminal. The initial coordinate system is used for defining the positional relationship between the first terminal and the second terminal when the map information is in the sharing state.

According to the embodiment of the disclosure, the device for aligning the coordinate systems includes the obtaining unit and the aligning unit. The obtaining unit is configured to obtain the map information from the first terminal in response to that the alignment of the coordinate systems is triggered. The aligning unit is configured to transform the initial coordinate system corresponding to the map information obtained from the first terminal into the second coordinate system of the second terminal. The initial coordinate system is used for defining the positional relationship between the first terminal and the second terminal when the map information is in the sharing state.

Functions or modules included in the device provided in some embodiments of the disclosure may be used for performing the method described in the above method embodiments. The descriptions of the above method embodiments may be referred to for the detailed implementation of device, which are not elaborated herein for the sake of brevity.

A computer-readable storage medium is also provided in an embodiment of the disclosure. Computer program instructions that implement the method for aligning the coordinate systems when executed by the processor are stored in the computer-readable storage medium. The computer-readable storage medium may be a non-volatile computer-readable storage medium.

An electronic device is also provided in an embodiment of the disclosure. The electronic device includes a processer and a memory used for storing instructions executable by the processor. The processor is configured to perform the method for aligning the coordinate systems.

The electronic device may be provided as a terminal, a server or devices in other forms.

A computer program is provided in an embodiment of the disclosure. The computer program includes computer-readable code. When the computer-readable code run in an electronic device, a processor in the electronic device performs the method for aligning the coordinate systems.

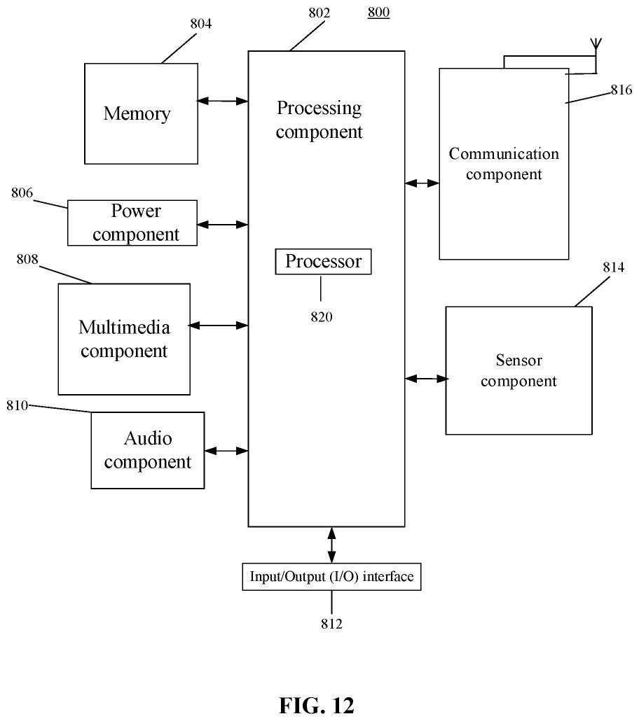

FIG. 12 is a block diagram of an electronic device according to an exemplary embodiment of the disclosure. For example, the electronic device 800 may be a terminal such as a mobile phone, a computer, a digital broadcast terminal, a messaging device, a gaming console, a tablet, a medical device, exercise equipment and a personal digital assistant and so on.

As illustrated in FIG. 12, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the operations in the above-mentioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focusing and optical zooming capability.

The audio component 810 is configured to output and/or input audio signals. For example, the audio component 810 includes a Microphone (MIC), and the MIC is configured to receive an external audio signal when the electronic device 800 is in an operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (Wi-Fi) network, a 2nd-Generation (2G), 3rd-Generation (3G), 4G, or 5G network or a combination thereof. In an exemplary embodiment, the communication component 816 receives a broadcast signal or broadcast associated information from an external broadcast management system through a broadcast channel. In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth™ (BT) technology and another technology.

In an exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic elements, and is configured to perform the above-described methods.

In an exemplary embodiment, there is also provided a non-transitory computer-readable storage medium such as the memory 804 including computer program instructions, and the computer program instructions may be executed by the processor 820 of the electronic device 800 to implement the above methods.

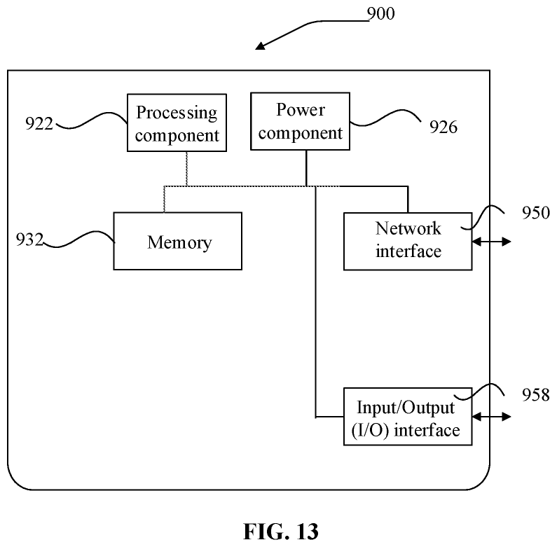

FIG. 13 is a block diagram of an electronic device 900 according to an embodiment of the disclosure. For example, the electronic device 900 may be provided as a server. As illustrated in FIG. 13, the electronic device 900 includes a processing component 922, which further includes one or more processors, and a memory resource which is represented by a memory 932 and used for storing instructions (such as application programs) executable by the processing component 922. The application programs stored in the memory 932 may include one or more modules, each of which corresponds to a group of instructions. Moreover, the processing component 922 is configured to execute the instructions to perform the above methods.

The electronic device 900 may further include a power component 926 configured to conduct power management of the electronic device 900, a wired or wireless network interface 950 configured to connect the electronic device 900 to a network, and an I/O interface 958. The device 900 may operate based on an operation system stored in the memory 932, such as Windows Server′, Mac OS X™, Unix™, Linux™, FreeBSD™ and the like.

In an exemplary embodiment, there is also provided a non-transitory computer-readable storage medium such as the memory 932 including computer program instructions, and the computer program instructions may be executed by the processing component 922 of the electronic device 900 to implement the above methods.

The embodiment of the disclosure may be a system, a method and/or a computer program product. The computer program product may include the computer-readable storage medium which is loaded with the computer-readable program instructions used for enabling a processor to implement each aspect of the disclosure.

The computer-readable storage medium may be a tangible device that can keep and store instructions used by an instruction-executing device. The computer-readable storage medium may be but is not limited to, for example, an electric storage device, a magnetic storage device, an optical storage device, an electromagnetic storage device, a semiconductor storage device or any suitable combination of the aforementioned devices. More specific examples (an non-exhaustive list) of the computer-readable storage medium include: a portable computer disk, a hard disk, a Random Access Memory (RAM), an ROM, an EPROM (or a flash memory), an SRAM, a Compact Disc Read-Only Memory (CD-ROM), a Digital Video Disk (DVD), a memory stick, a floppy disk, a mechanical encoding device, a punched card where instructions are stored or a protruding structure in a groove or any suitable combination thereof. The computer-readable storage medium used herein is not described as an instant signal such as a radio wave, other electromagnetic waves propagating freely, an electromagnetic wave propagating through a wave guide or other transmission media such as an optical pulse passing through a fiber-optic cable or an electric signal transmitting through electric wires.

The computer-readable program instructions described herein may be downloaded onto each computing or processing device from the computer-readable storage medium or onto an external computer or an external storage device through a network such as the Internet, a Local Area Network (LAN), a Wide Area Network (WAN) and/or a wireless network. The network may include a copper-transmitted cable, fiber-optic transmission, wireless transmission, a router, a firewall, a switch, a gateway computer and/or an edge server. A network adapter card or a network interface in each computing/processing device receives the computer-readable program instructions from the network and relays the computer-readable program instructions so that the computer-readable program instructions are stored in the computer-readable storage medium in each computing/processing device.

The computer program instructions used for performing the operations of the disclosure may be assembly instructions, Instruction Set Architecture (ISA) instructions, machine instructions, machine-related instructions, micro-codes, firmware instructions, state-setting data, source codes or target codes that are written in one programming language or any combination of several programming languages. The programming languages include object-oriented languages such as Smalltalk, C++, conventional procedure-oriented languages such as a “C” language or similar programming languages. The computer-readable program instructions can be completely or partially executed on a user computer, or executed as a separate software package. The computer-readable program instructions may also be partially executed on the user computer with the remaining executed on the remote computer, or completely executed on the remote computer or a server. In the case of the remote computer, the remote computer may connect to the user computer through any kind of network that includes the LAN and the WAN, or may connect to the external computer (for example, the remote computer may make the connection through the Internet with the help of an Internet service provider). In some embodiments, state information of the computer-readable program instructions is adopted to personalize an electric circuit such as a programmable logic circuit, a Field Programmable Gate Array (FPGA) and a Programmable Logic Array (PLA). The electric circuit may execute the computer-readable program instructions to implement each aspect of the disclosure.

Each aspect of the disclosure is described herein with reference to the flowcharts and block diagrams of the method, the device (the system) and the computer program product according to the embodiments of the disclosure. It should be understood that each block in the flowcharts and/or the block diagrams and combinations of each block in the flowcharts and/or the block diagrams may be implemented by the computer-readable program instructions.

The computer-readable program instructions may be provided to the processor of a general-purpose computer, a specific-purpose computer or another programmable data-processing device to produce a machine so that these instructions produce a device that implements functions/actions specified in one or more blocks in the flowcharts and/or the block diagrams, when executed through the processor of the computer or another programmable data-processing device. The computer-readable program instructions may also be stored in the computer-readable storage medium to make the computer, the programmable data-processing device and/or other devices to work in a specific manner. In this case, the computer-readable medium where the instructions are stored include a manufactured product that includes the instructions for implementing each aspect of the functions/the actions specified in one or more blocks in the flowcharts and/or the block diagrams.

The computer-readable program instructions may also be loaded on the computer, other programmable data-processing devices or other devices to make a series of operations performed on the computer, other programmable data-processing devices or other devices and establish procedures implemented by the computer so that the instructions executed in the computer, other programmable data-processing devices, or other devices implement the functions/the actions in one or more blocks of flowcharts and/or the block diagrams.

The flowcharts and the block diagrams in the accompanying drawings illustrate systems, architectures, functions and operations that are possibly implemented by the system, method and the computer program product according to the multiple embodiments of the disclosure. At this point, each block in the flowcharts or the block diagrams may represent a module, a program segment or a part of the instructions. The module, the program segment or the part of the instructions include one or more executable instructions used for implementing specified logical functions. In some implementations that serve as substitutes, the annotated functions in the block may also happen in an order different from the annotated order in the accompanying drawings. For example, depending on the relevant functions, two adjacent blocks actually may be basically executed in parallel or sometimes in opposite orders. It should also be noted that each block or a combination of the blocks in the block diagrams and/or the flowcharts may be implemented by a specific hardware-based system for performing specified functions or actions or be implemented by a combination of specific hardware and computer instructions.

Each embodiment of the disclosure has been described above. The above descriptions are not exhaustive but exemplary and are also not limited to each of the disclosed embodiments. Many changes and modifications are apparent to those of ordinary skills in the art without departing from the scope and the spirit of each of the described embodiments. The terminology used herein is chosen to best explain the principles, the practical applications or the improvement of the technologies in the market mentioned in each embodiment or enable others of ordinary skills in the art to understand each embodiment disclosed herein.

What is claimed is:

1. A method for aligning coordinate systems, comprising:
in response to that a second terminal triggers alignment of the coordinate systems, obtaining, by the second terminal, map information stored in a cloud, or obtaining, by the second terminal, map information from a first terminal; and
transforming, by the second terminal, a second coordinate system of the second terminal into an initial coordinate system corresponding to the map information stored in the cloud or into an initial coordinate system corresponding to the map information obtained from the first terminal, or transforming, by the second terminal, the initial coordinate system corresponding to the map information stored in the cloud or the initial coordinate system corresponding to the map information obtained from the first terminal into the second coordinate system of the second terminal,
wherein each initial coordinate system is used for defining a positional relationship between the first terminal and the second terminal when respective map information is in a sharing state.

2. The method of claim 1, wherein transforming, by the second terminal, the second coordinate system of the second terminal into the initial coordinate system corresponding to the map information stored in the cloud comprises:
establishing, by the second terminal, the second coordinate system of the second terminal according to the initial coordinate system; and
establishing, by the second terminal according to the map information stored in the cloud, map information that is based on the second coordinate system of the second terminal.

3. The method of claim 1, wherein transforming, by the second terminal, the second coordinate system of the second terminal into the initial coordinate system corresponding to the map information stored in the cloud comprises:
obtaining, by the second terminal, a relative transformation relationship of the second terminal with respect to the first terminal in the initial coordinate system;
correcting, by the second terminal, the second coordinate system of the second terminal according to the relative transformation relationship; and
establishing, by the second terminal according to the map information stored in the cloud, map information that is based on the corrected second coordinate system of the second terminal.

4. The method of claim 1, wherein transforming, by the second terminal, the initial coordinate system corresponding to the map information stored in the cloud into the second coordinate system of the second terminal comprises:
correcting, by the second terminal, the initial coordinate system according to a relative transformation relationship between poses of the second terminal in different coordinate systems; and
establishing, by the second terminal according to the map information stored in the cloud, map information that is based on the corrected initial coordinate system.

5. The method of claim 4, further comprising:
obtaining a first pose of the second terminal in the initial coordinate system;
obtaining a second pose of the second terminal in the second coordinate system of the second terminal; and
obtaining the relative transformation relationship according to the first pose and the second pose,
wherein the relative transformation relationship is used for representing a relative transformation relationship of a transformation from the initial coordinate system into the second coordinate system of the second terminal.

6. The method of claim 1, wherein the map information is determined by the first terminal based on a first coordinate system, and the first coordinate system is taken as the initial coordinate system, and wherein the map information is uploaded by the first terminal to a cloud or transmitted to the second terminal, to enable the second terminal to trigger alignment of the coordinate systems according to the map information.

7. The method of claim 1, wherein the map information is determined based on a first coordinate system of the first terminal; and
the map information is uploaded by the first terminal and transmitted to the second terminal via a server to enable the second terminal to trigger alignment of the coordinate systems according to the map information.

8. An electronic device, comprising:
a memory storing processor-executable instructions; and
a processor configured to execute the stored processor-executable instructions to perform operations of:
in response to that a second terminal triggers alignment of the coordinate systems, obtaining, by the second terminal, map information stored in a cloud, or obtaining, by the second terminal, map information from a first terminal; and
transforming, by the second terminal, a second coordinate system of the second terminal into an initial coordinate system corresponding to the map information stored in the cloud or into an initial coordinate system corresponding to the map information obtained from the first terminal, or transforming, by the second terminal, the initial coordinate system corresponding to the map information stored in the cloud or the initial coordinate system corresponding to the map information obtained from the first terminal into the second coordinate system of the second terminal,
wherein each initial coordinate system is used for defining a positional relationship between the first terminal and the second terminal when respective map information is in a sharing state.

9. The electronic device of claim 8, wherein transforming, by the second terminal, the second coordinate system of the second terminal into the initial coordinate system corresponding to the map information stored in the cloud comprises:
establishing, by the second terminal, the second coordinate system of the second terminal according to the initial coordinate system; and
establishing, by the second terminal according to the map information stored in the cloud, map information that is based on the second coordinate system of the second terminal.

10. The electronic device of claim 8, wherein transforming, by the second terminal, the second coordinate system of the second terminal into the initial coordinate system corresponding to the map information stored in the cloud comprises:
obtaining, by the second terminal, a relative transformation relationship of the second terminal with respect to the first terminal in the initial coordinate system;
correcting, by the second terminal, the second coordinate system of the second terminal according to the relative transformation relationship; and
establishing, by the second terminal according to the map information stored in the cloud, map information that is based on the corrected second coordinate system of the second terminal.

11. The electronic device of claim 8, wherein transforming, by the second terminal, the initial coordinate system corresponding to the map information stored in the cloud into the second coordinate system of the second terminal comprises:
correcting, by the second terminal, the initial coordinate system according to a relative transformation relationship between poses of the second terminal in different coordinate systems; and
establishing, by the second terminal according to the map information stored in the cloud, map information that is based on the corrected initial coordinate system.

12. The electronic device of claim 11, wherein the processor is configured to execute the stored processor-executable instructions to perform further operations of:
obtaining a first pose of the second terminal in the initial coordinate system;
obtaining a second pose of the second terminal in the second coordinate system of the second terminal; and
obtaining the relative transformation relationship according to the first pose and the second pose,
wherein the relative transformation relationship is used for representing a relative transformation relationship of a transformation from the initial coordinate system into the second coordinate system of the second terminal.

13. The electronic device of claim 8, wherein the map information is determined by the first terminal based on a first coordinate system, and the first coordinate system is taken as the initial coordinate system, and wherein the map information is uploaded by the first terminal to a cloud or transmitted to the second terminal, to enable the second terminal to trigger alignment of the coordinate systems according to the map information.

14. The electronic device of claim 8, wherein the map information is determined based on a first coordinate system of the first terminal; and
the map information is uploaded by the first terminal and transmitted to the second terminal via a server to enable the second terminal to trigger alignment of the coordinate systems according to the map information.

15. A non-transitory computer-readable storage medium having stored thereon computer-readable instructions that, when executed by a processor, cause the processor to perform a method for aligning coordinate systems, the method comprising:
in response to that a second terminal triggers alignment of the coordinate systems, obtaining, by the second terminal, map information stored in a cloud, or obtaining, by the second terminal, map information from a first terminal; and
transforming, by the second terminal, a second coordinate system of the second terminal into an initial coordinate system corresponding to the map information stored in the cloud or into an initial coordinate system corresponding to the map information obtained from the first terminal, or transforming, by the second terminal, the initial coordinate system corresponding to the map information stored in the cloud or the initial coordinate system corresponding to the map information obtained from the first terminal into the second coordinate system of the second terminal,
wherein each initial coordinate system is used for defining a positional relationship between the first terminal and the second terminal when respective map information is in a sharing state.

16. The non-transitory computer-readable storage medium of claim 15, wherein transforming, by the second terminal, the second coordinate system of the second terminal into the initial coordinate system corresponding to the map information stored in the cloud comprises:
establishing, by the second terminal, the second coordinate system of the second terminal according to the initial coordinate system; and
establishing, by the second terminal according to the map information stored in the cloud, map information that is based on the second coordinate system of the second terminal.

17. The non-transitory computer-readable storage medium of claim 15, wherein transforming, by the second terminal, the second coordinate system of the second terminal into the initial coordinate system corresponding to the map information stored in the cloud comprises:
obtaining, by the second terminal, a relative transformation relationship of the second terminal with respect to the first terminal in the initial coordinate system;
correcting, by the second terminal, the second coordinate system of the second terminal according to the relative transformation relationship; and
establishing, by the second terminal according to the map information stored in the cloud, map information that is based on the corrected second coordinate system of the second terminal.

18. The non-transitory computer-readable storage medium of claim 15, wherein transforming, by the second terminal, the initial coordinate system corresponding to the map information stored in the cloud into the second coordinate system of the second terminal comprises:
correcting, by the second terminal, the initial coordinate system according to a relative transformation relationship between poses of the second terminal in different coordinate systems; and
establishing, by the second terminal according to the map information stored in the cloud, map information that is based on the corrected initial coordinate system.

19. The non-transitory computer-readable storage medium of claim 18, wherein the method further comprises:
obtaining a first pose of the second terminal in the initial coordinate system;
obtaining a second pose of the second terminal in the second coordinate system of the second terminal; and
obtaining the relative transformation relationship according to the first pose and the second pose,
wherein the relative transformation relationship is used for representing a relative transformation relationship of a transformation from the initial coordinate system into the second coordinate system of the second terminal.

20. The non-transitory computer-readable storage medium of claim 15, wherein the map information is determined by the first terminal based on a first coordinate system, and the first coordinate system is taken as the initial coordinate system, and wherein the map information is uploaded by the first terminal to a cloud or transmitted to the second terminal, to enable the second terminal to trigger alignment of the coordinate systems according to the map information.
